(19) United States
(12) Patent Application Publication
(10) Pub. No.: US 2025/0001809 A1
(43) Pub. Date: Jan. 2, 2025

(54) Tire for an Urban Bus Comprising a Tread with Improved Grip

(71) Applicant: COMPAGNIE GENERALE DES ETABLISSEMENTS MICHELIN, Clermont-Ferrand (FR)

(72) Inventors: Frédéric DOMPROBST, Clermont-Ferrand Cedex 9 (FR); Paul LACOSTE, Clermont-Ferrand Cedex 9 (FR)

(21) Appl. No.: 18/688,214

(22) PCT Filed: Sep. 5, 2022
(86) PCT No.: PCT/FR2022/051665

§ 371 Date: Feb. 29, 2024

(30) Foreign Application Priority Data
Sep. 10, 2021 (FR) FR2109489

(51) Int. Cl. B60C 11/03

(52) U.S. Cl. CPC B60C 11/0309; B60C 2011/0346; B60C 2011/0355; B60C 2200/06

(57) ABSTRACT

A tire (1) for a heavy-duty vehicle for urban use and aims to improve the grip of the tire. The tire has a tread (2) which has at least two zigzag and mutually parallel wide cuts (41), referred to as grooves, each zigzag groove (41) is made up of alternating longitudinal portions (411), which are parallel to a longitudinal direction (XX′) of the tire, and oblique portions (412), each of which forms one and the same angle A with the longitudinal direction (XX′) at least equal to 15°, the depth of each zigzag groove (41) is at least equal to 7 mm, and the taper angle of each wall that delimits each zigzag groove (41) is at least equal to 10°.

The present invention relates to a tire for a heavy-duty vehicle for urban use, such as an urban bus, and relates more particularly to the tread of said tire.

A tread, made up of at least one rubber-based material, is the wearing part of the tire that provides the grip, is positioned around the periphery of the tire, and is intended to be worn away when in contact with the ground via a tread surface and to ensure the grip of the tire as it makes contact with the ground, which can be dry or wet.

To ensure its grip function, the tread generally comprises a pattern which is a combination of cuts, or voids, and raised elements of the block type or rib type. The proportion of cuts in a tread is usually quantified by a volumetric void ratio, defined as the ratio between the volume of cuts and the total volume of the tread assumed to be free of cuts, corresponding to the geometric volume delimited by the tread surface and a surface tangential to the deepest cut and parallel to the tread surface. In the case of a tire for an urban bus, the volumetric void ratio of the tread can reach a low value, typically less than 10%. Such a volumetric void ratio is possible since, taking account of the low speed of an urban bus, the discharge of water, which might be present on the ground, by the cuts of the tread does not require a high volume of cuts.

The cuts can be of two types: grooves and sipes. Grooves are wide cuts that are essentially for storing and discharging water that might be present on the ground. A cut is referred to as wide when it has a width such that the facing walls of material that delimit the cut do not come into contact with one another when the tread enters the contact patch, the tire being subject to recommended inflation and load conditions as are defined, for example, by the European standards of the “European Tire and Rim Technical Organization” or “E.T.R.T.O.” in its “Standards Manual 2020-Commercial Vehicle Tires”. Sipes are narrow cuts of which the intersections with the tread surface, or edge corners, contribute to grip on wet ground by virtue of an edge-corner effect in the contact patch which makes it possible to break the film of water present on the ground. A cut is referred to as narrow when it has a width such that the facing walls of material that delimit the cut come into contact with one another at least partially when the tread enters the contact patch, under the tire load and pressure conditions specified, for example, by the “E.T.R.T.O” standards, as seen above.

Moreover, the cuts may run in different directions and are usually classified as longitudinal, transverse or oblique cuts. A cut is referred to as longitudinal if its mean line forms a mean angle with the longitudinal direction of the tire, tangent to the tread surface along the direction of rotation of the tire, at most equal to 10°. A cut is referred to as transverse if its mean line forms a mean angle with the transverse direction of the tire, parallel to the axis of rotation of the tire, at most equal to 10°. A cut is referred to as oblique if it is neither longitudinal nor transverse, that is to say if it forms a mean angle with the longitudinal direction of greater than 10° and less than 80°. By definition, the mean line of a cut is the intersection of the tread surface with a mean surface of the cut, perpendicular to the tread surface and equidistant from the walls of material that delimit the cut: it is therefore the path of the mean surface of the cut on the tread surface of the tire.

Safety is an ongoing concern for manufacturers and users of urban vehicles. Consequently, grip on dry ground and on wet ground is a fundamental performance desired by tire manufacturers.

The inventors have also set themselves the objective of further improving the grip of a tire for a heavy-duty vehicle for urban use, such as an urban bus, which comprises a tread having in particular a low volumetric void ratio, on dry ground and on wet ground, in order to ensure the required level of safety.

This objective has been achieved by a tire for a heavy-duty vehicle for urban use, comprising a tread intended to come into contact with the ground via a tread surface,
the tread having a transverse width, measured between two transverse ends of the tread surface, along a transverse direction parallel to an axis of revolution of the tire, and comprising cuts that delimit raised elements,
every cut being delimited by two walls that intersect the tread surface along two edge corners,
every cut having a thickness, measured on the tread surface between the two edge corners, perpendicularly to the two edge corners, and a depth, measured between the tread surface and a cut bottom, perpendicularly to the tread surface,
each wall forming, in any plane perpendicular to said wall, a taper angle with the straight line that passes through the edge corner, which is the intersection of said wall with the tread surface, and is perpendicular to the tread surface,
the tread comprising at least two zigzag and mutually parallel wide cuts, referred to as grooves,
each zigzag groove being made up of alternating longitudinal portions, which are parallel to a longitudinal direction of the tire, and oblique portions, each of which forms one and the same angle with the longitudinal direction at least equal to 15°,
the depth of each zigzag groove being at least equal to 7 mm,
and the taper angle of each wall that delimits each zigzag groove being at least equal to 10°.

The essential principle of the invention is to provide a tread with a system of cuts, at least two of which are wide and have an oblique overall orientation with good effectiveness as regards the transverse grip and the longitudinal grip.

A wide cut is understood to mean a cut of which the walls of material delimiting it are far enough apart that they do not come into contact with one another while the tire is running, when the cut enters the contact patch: such a wide cut is usually referred to as groove. Moreover, this groove must be deep enough, with a minimum depth equal to 7 mm, to ensure a volume for storing and discharging water potentially present on the ground if it is raining, and therefore sufficient grip on wet ground. Lastly, the walls delimiting such a groove must have a sufficient inclination, with an angle, referred to as taper angle, at least equal to 10°, this taper angle being measured in a plane perpendicular to the axis of revolution of the tire and with the straight line that passes through the corresponding edge corner and is perpendicular to the tread surface. A taper angle which is high enough makes it possible to obtain a stiffness of the raised elements delimiting the cut that makes it possible to ensure satisfactory wear resistance of the tread. It should be noted that the two facing walls do not necessarily have the same taper angle value.

Oblique overall orientation is understood to mean a mean direction of the wide groove that forms an angle with the longitudinal direction of the tire typically greater than 10° and less than 80°. Within the context of the invention, the groove has a zigzag shape made up of alternating longitudinal portions and oblique portions oscillating about an oblique mean straight line, the oblique portions forming an angle with the longitudinal direction at least equal to 10°. The longitudinal portions, having longitudinal edge corners, are effective as regards transverse grip. The oblique portions have edge corners having a longitudinal component which is effective as regards transverse grip and a transverse component which is effective as regards longitudinal grip. As a result, such an oblique wide groove is effective as regards respectively transverse grip and longitudinal grip. Consequently, a network of such oblique wide grooves is as effective as a network of longitudinal and transverse grooves as regards grip, with a lower volume of cuts, and therefore a greater volume of material that can wear. It is therefore a system of cuts which is particularly advantageous for ensuring good grip of a tread with a low volumetric void ratio.

Moreover, the presence of longitudinal portions is advantageous from the perspective of assembling the curing mould elements intended for the production of the tread pattern, since these elements can be easily interconnected at said longitudinal portions with high precision.

It is advantageous for the taper angle of each wall delimiting each zigzag groove to be at most equal to 25°, since above this angle value the groove volume becomes too small to ensure effective storage and discharge of water that might be present in the contact patch.

Advantageously, each oblique portion of each zigzag groove forms an angle with the longitudinal direction of the tire at least equal to 30° and at most equal to 45°, preferably at most equal to 40°.

Below 30°, the transverse component of the oblique-portion edge corners is of limited magnitude and therefore less effective as regards longitudinal grip. Above 45°, the oblique portion has an inclination which does not allow it to lead out as it enters and leaves the contact patch or, therefore, to channel the water that might be present on the ground, resulting in a worse performance in terms of grip on wet ground.

More advantageously, with the tire having an outside diameter D and an outer circumference π*D, each longitudinal portion of each zigzag groove having a longitudinal length, measured on the tread surface, along the longitudinal direction of the tire, at least equal to 0.5*π*D/120 and at most equal to 2*π*D/120.

This range of values enables an advantageous compromise between the rolling resistance, which is all the lower the greater the longitudinal length of each longitudinal portion, and traction on snow, which is all the better the smaller the longitudinal length of each longitudinal portion. By way of example, a longitudinal length equal to 25 mm is an advantageous choice for a tire for urban use. However, a longitudinal length reduced to 12 mm is a more suitable choice for a tire intended to run on snow. By contrast, a longitudinal length increased to 50 mm is more effective for a tire for long distance use, for which the rolling resistance is to be optimized.

Also advantageously, the longitudinal portions of every first zigzag groove are longitudinally offset in relation to the longitudinal portions of every second zigzag groove, such that any two longitudinal portions respectively of said first zigzag groove and said second zigzag groove do not simultaneously enter the contact patch when the tire is running.

Using “first end of a longitudinal portion” to refer to the end intended to enter the contact patch first, any transverse straight line passing through a first end of a longitudinal portion of a given first zigzag groove does not pass through any other first end of a longitudinal portion of a second zigzag groove. This implies that the respective longitudinal portions of two zigzag grooves do not simultaneously enter the contact patch. This results in a reduction in the running noise generated by the circulation of air in said zigzag grooves.

With preference, no zigzag groove leads out at a transverse end of the tread surface.

This absence of grooves leading out at the edges of the tread makes it possible to stiffen the edges of the tread by way of the presence of a continuous rib, and therefore to reinforce the edges of the tread and also reduce the risk of irregular wear patterns appearing at the edge of the tread.

With further preference, the transversely outermost longitudinal portions of the zigzag grooves are positioned, with respect to a median circumferential plane of the tire, at a distance at most equal to 40% of the transverse width of the tread.

In this particular embodiment, each continuous rib at the edge of the tread is consequently wide enough to resist chunking that results, for example, from the tire impacting against kerbs, which is a frequent occurrence in urban use.

According to an advantageous embodiment of the zigzag grooves, at least one of the zigzag grooves is continued radially towards the inside, from its cut bottom, by a sipe.

Such a zigzag groove continued radially towards the inside by a sipe is referred to as stepped. As a reminder, a sipe is a cut which has a smaller thickness than a groove and the walls of which are intended to partially come into contact with one another while the tire is running. In such a stepped groove, the sipe would therefore appear on the tread surface after a certain degree of wear of the tread. A stepped groove, owing to the presence of a sipe that continues it in the thickness of the tread, enables greater mobility of the raised elements of material which it delimits, and therefore contributes to the tread flattening more easily, thereby limiting sliding in the contact patch and therefore slowing down the wear. The tread flattening more easily also promotes a reduction in the rolling resistance. Moreover, a stepped groove ensures the presence of two facing edge corners as the tread wears—the wear first of all affecting the radially outer groove and then the radially inner sipe—resulting in long-lasting grip throughout the lifetime of the tire. This sipe, owing to its small thickness, has little impact on the volume of cuts, and therefore the volumetric void ratio: consequently, it does not have a significant impact on the lifetime in terms of wear.

According to an advantageous embodiment of the tread pattern, the tread comprises at least one sipe which leads out on the tread surface and is parallel to at least two zigzag grooves.

The presence of at least one zigzag sipe parallel to at least two zigzag grooves according to the invention makes it possible to increase the number of edge corners, which promotes grip, without increasing the volumetric void ratio, which is favourable to the lifetime in terms of wear.

According to an advantageous embodiment of said at least one zigzag sipe, said at least one sipe is continued radially towards the inside by a groove.

Such a zigzag sipe continued radially towards the inside by a groove is referred to as stepped. As a reminder, a groove is a cut which has a greater thickness than a sipe and the walls of which are intended to not come into contact with one another while the tire is running. In such a stepped sipe, the groove would therefore appear on the tread surface after a certain degree of wear of the tread. A stepped sipe, owing to the presence of a groove continuing it in the thickness of the tread, makes it possible to increase the volume of cuts in the surface, after a certain degree of wear, making it possible to restore water storage and discharge capacity. It thus makes it possible to compensate the loss of storage capacity of a stepped groove which transforms into a sipe as the tire wears. By way of example, such a groove radially on the inside of a sipe leading out in the surface has walls having a minimum taper angle of 10° and a minimum width at the groove bottom of 2 mm.

For a tire for urban use, with the tread having a volumetric void ratio, defined as the ratio between the volume of cuts and the total volume of the tread assumed to be free of cuts, corresponding to the geometric volume delimited by the tread surface and a surface tangential to the deepest cut and parallel to the tread surface, the volumetric void ratio is at most equal to 10%, to comply with the desired performance in terms of lifetime.

With the tire according to one of the preceding embodiments of the invention comprising a crown reinforcement comprising at least two working layers made up of reinforcers coated in a rubber compound and crossed from one working layer to the next, the reinforcers of each of the at least two working layers form an angle with the longitudinal direction of the tire at least equal to 15° and at most equal to 35°.

It is known that the combination of the angles of the respective reinforcers of the working layers generates transverse forces, referred to as ply steer, in the crown of the tire owing to a triangulation effect. The inclination of the zigzag grooves according to the invention causes the stiffness of the tread to be orthotropic, which offsets said ply steer effect and contributes to a better balance of the transverse forces acting on the tire.

According to a particular embodiment of the crown reinforcement, the crown reinforcement comprises at least one hooping layer, which is made up of reinforcers which are coated in a rubber compound and are parallel to the longitudinal direction of the tire, and is radially interposed between two working layers.

The presence of a hooping layer, characterized by longitudinal reinforcers, between the two working layers increases the radial distance between the two working layers and contributes to enhancing the ply steer force. A tread pattern according to the invention then becomes particularly advantageous for balancing said ply steer force.

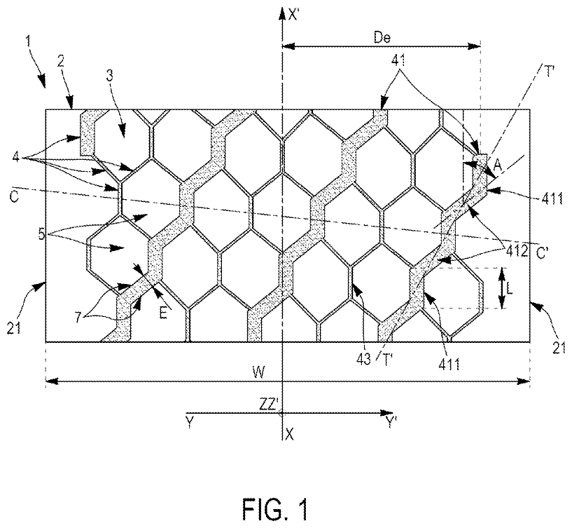

The features of the invention will be better understood with the aid of FIGS. 1 to 5, which are not to scale:

FIG. 1: A plan view of a tread of a tire for an urban bus according to the invention,

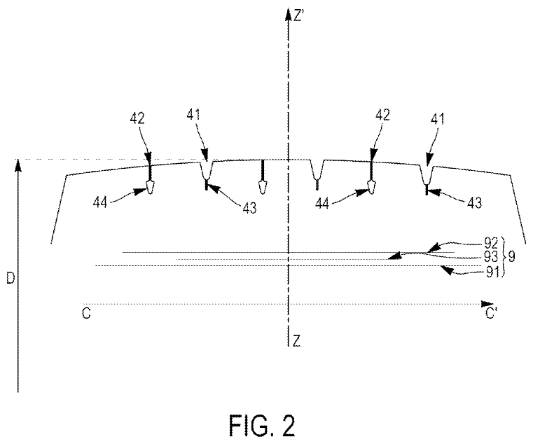

FIG. 2: A sectional view of a tread of a tire for an urban bus according to the invention, along a sectional plane CC′ perpendicular to the axis of rotation of the tire,

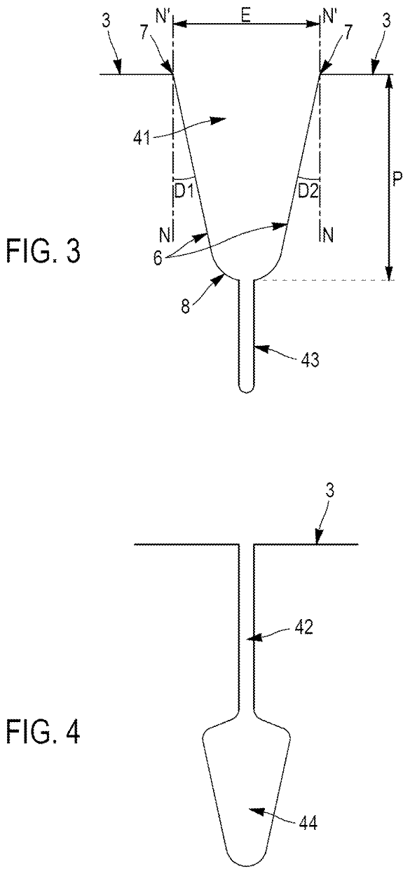

FIG. 3: A sectional view of a zigzag groove, perpendicular to said zigzag groove, which is continued radially towards the inside by a sipe,

FIG. 4: A sectional view of a zigzag sipe, perpendicular to said zigzag sipe, which is continued radially towards the inside by a groove,

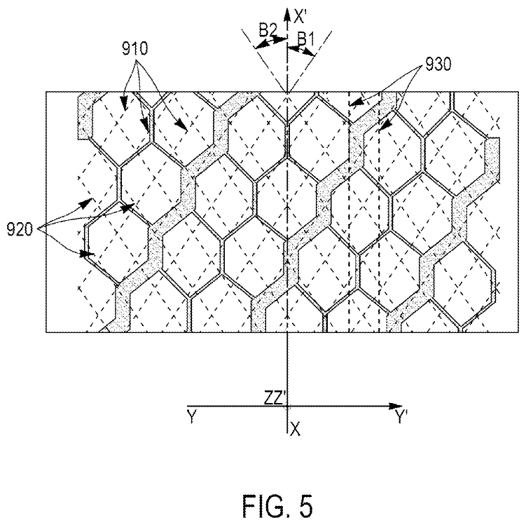

FIG. 5: A diagram of the respective orientations of the zigzag grooves and the reinforcers of the working and hooping layers, respectively, of the crown reinforcement of a tire according to the invention.

FIG. 1 is a plan view of a tread 2 of a tire 1 for an urban bus according to the invention. The tread 2, which is intended to come into contact with the ground via a tread surface 3, has a transverse width W, measured between two transverse ends 21 of the tread surface 3, along a transverse direction YY′ parallel to an axis of revolution of the tire. The tread 2 comprises cuts 4 that delimit raised elements 5. Every cut 4 is delimited by two walls intersecting the tread surface 3 along two edge corners 7 and has a thickness E, measured on the tread surface 3, between the two edge corners 7, perpendicularly to the two edge corners 7. According to the invention, the tread 2 comprises at least two zigzag and mutually parallel wide cuts 41, referred to as grooves. Each zigzag groove 41, which oscillates about a straight line T′T′, is made up of alternating longitudinal portions 411, which have a circumferential length L and are parallel to a longitudinal direction XX′ of the tire, and oblique portions 412, which each form one and the same angle A with the longitudinal direction XX′ at least equal to 15°. In the embodiment shown, no zigzag groove 41 leads out at a transverse end 21 of the tread surface 3. Moreover, the tread comprises a sipe 43 which leads out on the tread surface 3, interposed between two consecutive zigzag grooves 41, and is parallel to said zigzag grooves 41.

FIG. 2 is a sectional view of a tread 2 of a tire for an urban bus according to the invention, along a sectional plane CC′ intersecting all the zigzag cuts (41, 42) of the tread, as shown in FIG. 1. In the embodiment shown, 3 wide cuts or grooves 41 alternate with 3 narrow cuts or sipes 42. Each zigzag groove 41 is continued radially towards the inside by a sipe 43. Each zigzag sipe 42 is continued radially towards the inside by a groove 44. Moreover, the tire comprises a crown reinforcement 9 comprising at least two working layers (91, 92) made up of reinforcers coated in a rubber compound and crossed from one working layer to the next. The crown reinforcement 9 also comprises a hooping layer 93, which is made up of reinforcers which are coated in a rubber compound and are parallel to the longitudinal direction of the tire, and is radially interposed between the two working layers (91, 92).

FIG. 3 is a sectional view of a zigzag groove 41, perpendicular to said zigzag groove 41, which is continued radially towards the inside by a sipe 43. The zigzag groove 41 is delimited by two walls 6 intersecting the tread surface 3 along two edge corners 7. It has a thickness E, measured on the tread surface 3 between the two edge corners 7, perpendicularly to the two edge corners 7, and a depth P, measured between the tread surface 3 and a cut bottom 8, perpendicularly to the tread surface 3. Each wall 6 forms, in any plane perpendicular to said wall 6, a taper angle (D1, D2) with the straight line NN′ that passes through the edge corner 7, which is the intersection of said wall 6 with the tread surface 3, and is perpendicular to the tread surface 3. According to the invention, the depth P of each zigzag groove 41 is at least equal to 7 mm and the taper angle (D1, D2) of each wall 6 delimiting each zigzag groove 41 is at least equal to 10°.

FIG. 4 is a sectional view of a zigzag sipe 42, perpendicular to said zigzag sipe 42, which is continued radially towards the inside by a groove 44.

FIG. 5 is a diagram of the respective orientations of the zigzag grooves 41 and the reinforcers of the working (91, 92) and hooping (93) layers, respectively, of the crown reinforcement 9 of a tire according to the invention, as are shown in FIG. 2. According to an advantageous embodiment, the reinforcers (910, 920) of each of the two working layers (91, 92) form an angle (B1, B2) with the longitudinal direction (XX′) of the tire at least equal to 15° and at most equal to 35°, the reinforcers 930 of the hooping layer 93 being, by definition, parallel to the longitudinal direction XX′.

The invention has been investigated in more detail for a tire of size 275/70R22.5 X Incity Michelin, which is intended to equip an urban bus. For such a tire, the recommended inflation pressure is equal to 9 bar, the recommended static load is equal to 3550 kg and the recommended maximum speed is equal to 100 km/h.

Table 1 below shows the characteristics of the tread that was tested:

TABLE 1

| Characteristics | Values | | Comments |
|---|---|---|---|
| Transverse width W of tread (2) | 255 | mm | |
| Outside diameter D of tire (1) | 969 | mm | |
| Thickness E of zigzag groove (41) | 7 | mm | |
| Depth P of zigzag groove (41) | 12 | mm | |
| Taper angle (D1, D2) of walls (6) | 10° | | At least equal |
| of zigzag groove (41) | | | to 10° |
| Angle A of oblique portions (412) | 35° | | At least equal |
| of zigzag groove (41) | | | to 15° and at |
| | | | most equal to 45° |
| Longitudinal length L of longitudinal | 25 | mm | Comprised |
| portions (411) of zigzag groove (41) | | | between 0.5 * |
| | | | π * D/120 = |
| | | | 12.5 mm and |
| | | | 2 * π * D/ |
| | | | 120 = 50 mm |
| Distance De of transversely outermost | 98 | mm | At most equal |
| longitudinal portions (411) of zigzag | | | to 40% W = |
| groove (41) with respect to medial | | | 102 mm |
| circumferential plane (XZ) | | | |

| | | |
|---|---|---|
| Volumetric void ratio TEV | 8.4% | At most equal |
| | | to 10% |
| Angles (B1, B2) of reinforcers of | 18°/−30° | At least equal |
| working layers with respect to | | to 15° and at |
| longitudinal direction (XX′) | | most equal to 35° |
| | | in absolute terms |

The finite-element digital simulations and the tests carried out on a tire according to the invention, as characterized in the above Table 1, demonstrated, in relation to a reference tire 275/70R22.5, a +40% increase in grip capability, both in terms of traction and braking, with a 5% reduction in the rolling resistance, for the same lifetime in terms of wear.

1. A tire for a heavy-duty vehicle for urban use, comprising a tread intended to come into contact with the ground via a tread surface,
the tread having a transverse width (W), measured between two transverse ends of the tread surface, along a transverse direction (YY′) parallel to an axis of revolution of the tire, and comprising cuts that delimit raised elements,
every cut being delimited by two walls that intersect the tread surface along two edge corners,
every cut having a thickness (E), measured on the tread surface-between the two edge corners, perpendicularly to the two edge corners, and a depth (P), measured between the tread surface and a cut bottom, perpendicularly to the tread surface,
each wall forming, in any plane perpendicular to said wall, a taper angle (D1, D2) with the straight line (NN′) that passes through the edge corner, which is the intersection of said wall with the tread surface, and is perpendicular to the tread surface,
wherein the tread comprises at least two zigzag and mutually parallel wide cuts, referred to as grooves, in that each zigzag groove is made up of alternating longitudinal portions, which are parallel to a longitudinal direction (XX′) of the tire, and oblique portions, each of which forms one and the same angle (A) with the longitudinal direction (XX′) at least equal to 15°, in that the depth (P) of each zigzag groove is at least equal to 7 mm, and in that the taper angle (D1, D2) of each wall that delimits each zigzag groove is at least equal to 10°.

2. The tire according to claim 1, wherein each oblique portion of each zigzag groove forms an angle (A) with the longitudinal direction (XX′) of the tire at least equal to 30° and at most equal to 45°.

3. The tire according to claim 1, wherein the tire has an outside diameter D and an outer circumference π*D, and wherein each longitudinal portion of each zigzag groove has a longitudinal length (L), measured on the tread surface, along the longitudinal direction (XX′) of the tire, at least equal to 0.5*π*D/120 and at most equal to 2*π*D/120.

4. The tire according to claim 1, wherein
the longitudinal portions of every first zigzag groove are longitudinally offset in relation to the longitudinal portions of every second zigzag groove, such that any two longitudinal portions, respectively, of said first zigzag groove and said second zigzag groove do not simultaneously enter the contact patch when the tire is in operation.

5. The tire according to claim 1, wherein no zigzag groove leads out at a transverse end of the tread surface.

6. The tire according to claim 5, wherein the transversely outermost longitudinal portions of the zigzag grooves are positioned, with respect to a median circumferential plane (XZ) of the tire, at a distance (De) at most equal to 40% of the transverse width (W) of the tread.

7. The tire according to claim 1, wherein at least one of the zigzag grooves is continued radially towards the inside, from its cut bottom, by a sipe.

8. The tire according to claim 1, wherein the tread comprises at least one sipe which leads out on the tread surface and is parallel to at least two zigzag grooves.

9. The tire according to claim 8, wherein said at least one sipe is continued radially towards the inside by a groove.

10. The fire according to claim 1, wherein the tread has a volumetric void ratio, defined as the ratio between the volume of cuts and the total volume of the tread assumed to be free of cuts, corresponding to the geometric volume delimited by the tread surface and a surface tangential to the deepest cut and parallel to the tread surface, and wherein the volumetric void ratio is at most equal to 10%.

11. The tire according to claim 1, comprising a crown reinforcement comprising at least two working layers made up of reinforcers coated in a rubber compound and crossed from one working layer to the next, wherein the reinforcers of each of the at least two working layers form an angle (B1, B2) with the longitudinal direction (XX′) of the tire at least equal to 15° and at most equal to 35°.

12. The tire according to claim 11, wherein the crown reinforcement comprises at least one hooping layer which is made up of reinforcers which are coated in a rubber compound and are parallel to the longitudinal direction (XX′) of the tire, and is radially interposed between two working layers.
